(19) United States
(12) Patent Application Publication
(10) Pub. No.: US 2026/0007560 A1
(43) Pub. Date: Jan. 8, 2026

(54) Bariatric Airway Management and Patient Securement Pillow

(71) Applicants: DeRoyal Industries, Inc., Powell, TN (US); Health and Safety Technologies, LLC (HST), Wartrace, TN (US)

(72) Inventors: Rex Allen Grindstaff, Wartrace, TN (US); Timothy James Grassi, Knoxville, TN (US); Morgan Waite, Knoxville, TN (US); Albert Pendleton Gillespie, III, Jacksboro, TN (US); Phillip David Peery, Sweetwater, TN (US)

(73) Assignees: DeRoyal Industries, Inc., Powell, TN (US); Health and Safety Technologies, LLC (HST), Wartrace, TN (US)

(21) Appl. No.: 19/257,595

(22) Filed: Jul. 2, 2025

Related U.S. Application Data
(60) Provisional application No. 63/668,693, filed on Jul. 8, 2024.

(51) Int. Cl. A61G 13/12

(52) U.S. Cl. CPC A61G 13/1215

(57) ABSTRACT

The disclosure provides surgical pillows having a foam body having a front ramp abutting and aligned with a planar central plateau having an upper surface, the front ramp including side flares sloping away from opposite sides of the front ramp; side members located on opposite sides of the front ramp and the central plateau and extending upwardly above the front ramp and the central plateau; a channel formed across at least a portion of the width of the pillow and vertically lower than the upper surface of the central plateau; and a rigid securement member having a vertical member securable in a fixed position relative to the patient support surface and a horizontal member received within the channel to fix the position of the surgical pillow relative to the patient support surface.

### FIELD

The present disclosure relates to surgical pillows. More particularly, the disclosure relates to a pillow and associated securement devices for positioning a patient on an operating table in a steep Trendelenburg position or like steep position and to better support, stabilize and secure the head, the upper thoracic and cervical spine, and the torso of the patient on the table and prevent slipping or movement of the patient relative to the operating table.

### BACKGROUND

Improvement is desired in devices for positioning patients on an operating room table. In particular, improvement is needed in devices for positioning a patient on an operating table in multiple Trendelenburg positions or Lateral Oblique positions. In these positions the patient is maintained at a steep angle greater than about 28 degrees. These positions are desirable for various medical procedures.

In the Trendelenburg position, the patient is flat on the operating table and the table is angled along its length axis so that the feet of the patient are vertically higher than the head of the patient.

As will be appreciated, it becomes difficult to securely restrain a patient against movement and in a desired position in steep angle positions. Also, airway management of the patient is also important in any surgical procedure and can become difficult in the Trendelenburg position.

In bariatric surgery, the Trendelenburg position is often used to improve surgical access to the pelvic area. As the patients of bariatric surgery are often of heavier weight, this additional weight of the patient can increase positioning and airway management difficulties.

The devices according to the disclosure are configured to facilitate the provisions of management for patients including bariatric patients; and facilitate positioning for known difficult intubation patients; and provide positioning that helps to avoid patients from migrating/slipping down the surgical table.

### SUMMARY

The disclosure advantageously provides surgical pillows positionable on a patient support surface and securable in a fixed position relative to the patient support surface.

In one aspect, a surgical pillow according to the disclosure includes a foam body having a front ramp abutting and aligned with a planar central plateau having an upper surface, the front ramp including side flares sloping away from opposite sides of the front ramp; side members located on opposite sides of the front ramp and the central plateau and extending upwardly above the front ramp and the central plateau; a channel formed across at least a portion of the width of the pillow and vertically lower than the upper surface of the central plateau; and a rigid securement member having a vertical member securable in a fixed position relative to the patient support surface and a horizontal member received within the channel to fix the position of the surgical pillow relative to the patient support surface.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIGS. 1A-1D show a first embodiment of a bariatric airway management and patient securement pillow according to the disclosure.

FIGS. 2A-2D show a second embodiment of a bariatric airway management and patient securement pillow according to the disclosure.

FIG. 3 shows the pillow of the second embodiment installed on an operating table.

FIGS. 4 and 5 are close-up views showing components utilized to install the pillow on the operating table.

FIGS. 6, 7 and 8 are perspective views of different bars utilized to install the pillow on the operating table.

FIG. 9 shows a third embodiment of a bariatric airway management and patient securement pillow according to the disclosure.

### DETAILED DESCRIPTION

The disclosure relates to surgical pillows in the nature of bariatric airway management and patient securement pillows. The pillows and associated securement devices are configured for positioning a patient on a surface such as an operating table in a steep Trendelenburg position or like steep position to better support, stabilize and secure the head, the upper thoracic and cervical spine, and the torso of the patient on the table and prevent slipping or movement of the patient relative to the operating table. The pillows are also aesthetically pleasing to provide a visually appealing appearance.

The pillows may be provided to be single use disposable and reusable, with an antimicrobial coating or covering. The pillows described herein may be made of foam of various types, weights and densities. The pillows may be of one-piece construction or may be made with foam of different densities for various parts of the pillow adhered together to provide a unitary pillow structure. Foam densities of from about 1.0 to about 2.0 lbs/in³ are preferred.

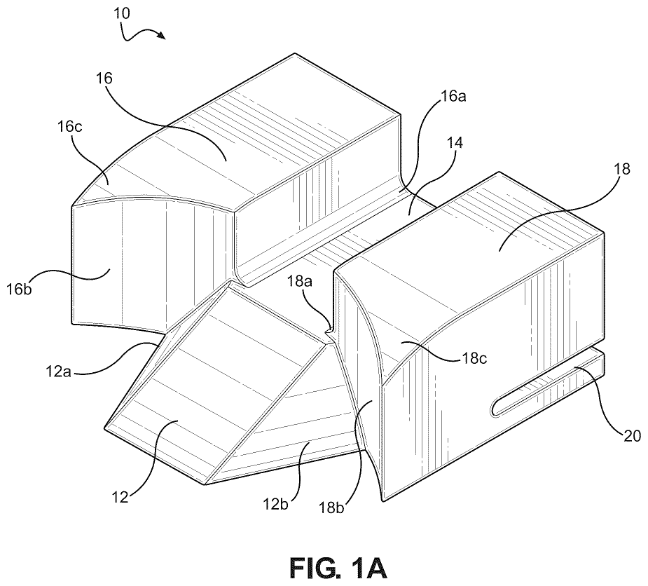

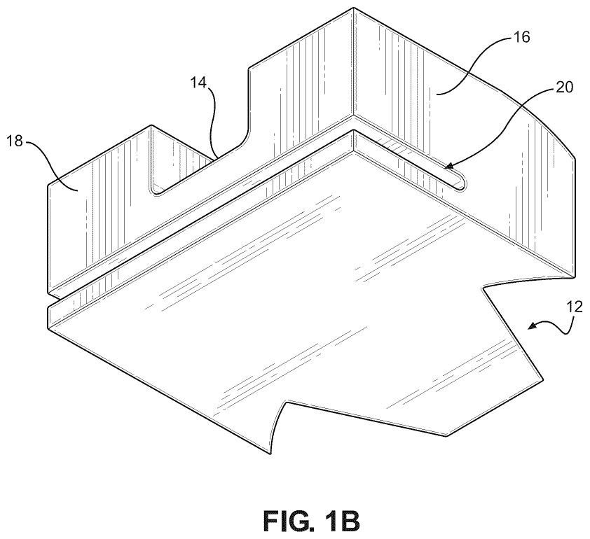

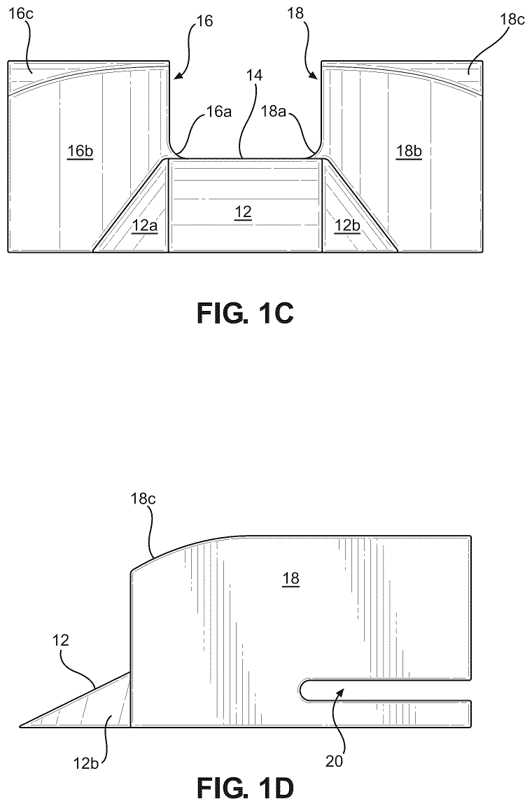

FIGS. 1A-1D shows a first embodiment of a bariatric airway management and patient securement pillow 10. The pillow 10 has a front ramp 12 abutting and aligned with a planar central plateau 14 open to the rear of the pillow 10 and having a planar upper surface configured to receive the head of a patient. The front ramp 12 includes side flares 12a and 12b. The front ramp 12 and the side flares 12a and 12b are each planar surfaces each having a uniform slope along their lengths.

Side members 16 and 18 are located on opposite sides of the ramp 12 and the central plateau 14. A channel 20 is formed across the width of the pillow 10 and opens to the rear of the pillow 10. The channel 20 desirably begins about midway of the depth of the side members 16 and 18 and extends below the upper surface of the central plateau 14. The bottom of the pillow 10 is desirably uniform and planar as seen in FIG. 1B.

The side members 16 and 18 extend upwardly above the front ramp 12 and the central plateau 14 and U-shaped cuts 16a and 18a of the side members 16 and 18, respectively, soften the juncture of the side members 16 and 18 to the sides of the central plateau 14. The side members 16 and 18 include curved front walls 16b and 18b, respectively, that extend forward of the central plateau 14 and curve outwardly from a juncture with the central plateau 14. The upper surfaces of the side members 16 and 18 are planar, except for portions 16c and 18c of the upper surfaces of the side members 16 and 18 that overly the curved front walls 16b and 18b, respectively, and curve downwardly.

The front ramp 12 receives the upper thoracic and cervical spine of the patient and the central plateau 14 receives the head of the patient. The side flares 12a and 12b cooperate with the curved front walls 16b and 18b for receiving the upper arms and shoulders of the patient.

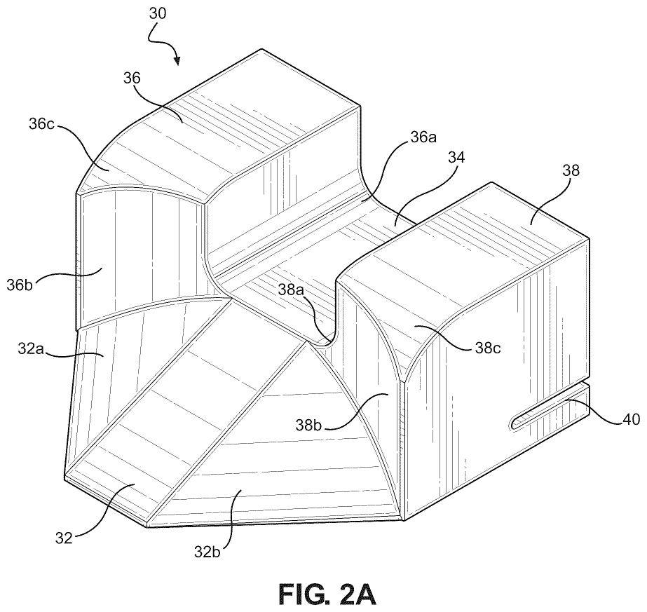

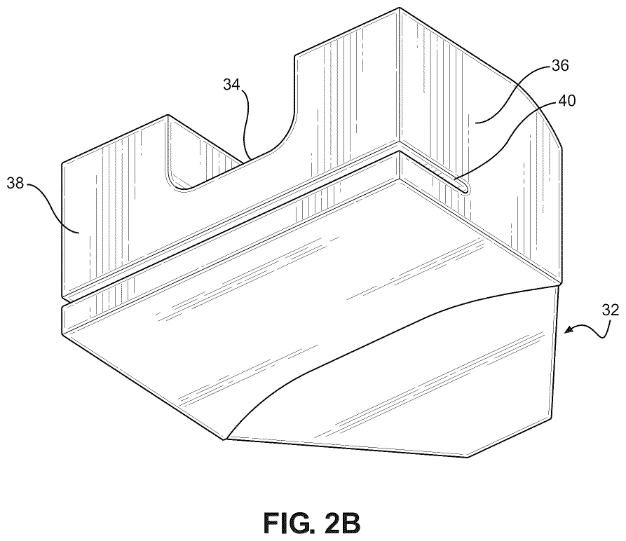

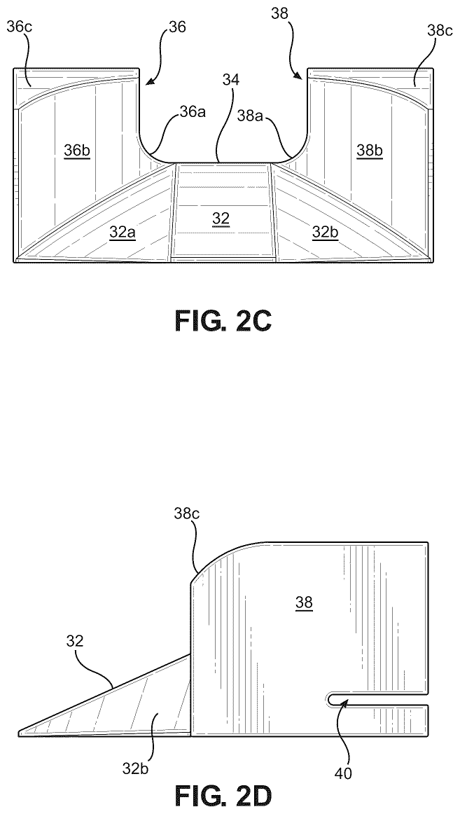

FIGS. 2A-2D show a second embodiment of a bariatric airway management and patient securement pillow 30. The pillow 30 has a front ramp 32 abutting and aligned with a planar central plateau 34 open to the rear of the pillow 30 and having a planar upper surface configured to receive the head of a patient. The front ramp 32 includes side flares 32a and 32b. The front ramp 32 is planar having a uniform slope of from about 20 to about 30 degrees, most preferably about 25 degrees, along its length. The side flares 32a and 32b are outwardly curved or convex. The bottom of the pillow 30 is desirably uniform and planar as seen in FIG. 2B.

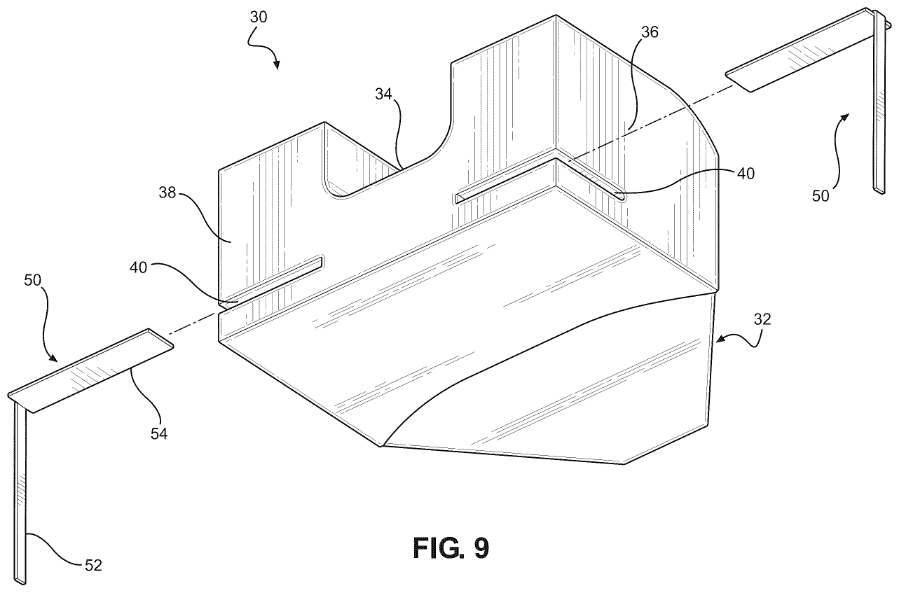

Side members 36 and 38 are located on opposite sides of the ramp 32 and the central plateau 34. A channel 40 is formed across the width of the pillow 30 and opens to the rear of the pillow 30. The channel 40 is shown as a slot but can have other profile features and desirably begins about midway of the depth of the side members 36 and 38 and extends below the upper surface of the central plateau 34. However, if desired, portions of the channel 40 may be filled with a foam or other insert, such as the portion below the central plateau. FIG. 9 shows an alternate embodiment in which foam material at the location of the channel 40 below the central plateau 34 is not removed.

The side members 36 and 38 extend upwardly above the front ramp 32 and the central plateau 34 and U-shaped cuts 36a and 38a of the side members 36 and 38, respectively, soften the juncture of the side members 36 and 38 to the sides of the central plateau 34. The side members 36 and 38 include curved front walls 36b and 38b, respectively, that extend forward of the central plateau 34 and curve outwardly from a juncture with the central plateau 34. The upper surfaces of the side members 36 and 38 are planar, except for portions 36c and 38c of the upper surfaces of the side members 36 and 38 that overly the curved front walls 36b and 38b, respectively, and curve downwardly.

The front ramp 32 receives the upper thoracic and cervical spine of the patient and the central plateau 34 receives the head of the patient. The side flares 32a and 32b cooperate with the curved front walls 36b and 38b for receiving the upper arms and shoulders of the patient.

For the described pillow 30, the foam used is desirably as set forth in Table 1:

TABLE 1

| | |
|---|---|
| Front ramp 32 | Density 1.2 lbs/in³ |
| | Indentation load deflection 30 |
| Central plateau 34 & | Density 1.5 lbs/in³ |
| Side members 36 and 38 | Indentation load deflection 55 |

Density and Indentation load deflection are tested according to ASTM D3574-17 (last updated Mar. 29, 2017).

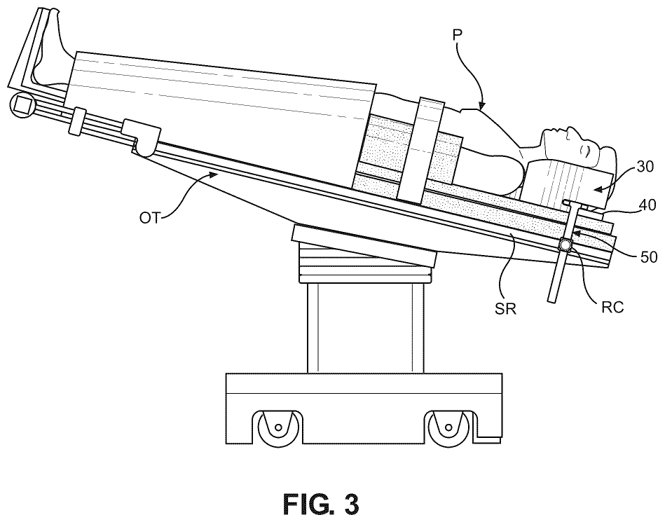

FIG. 3 shows the pillow 30 installed on an operating table supporting a patient P against movement on a patient support surface such as a bed or an operating table OT, including when the operating table OT is oriented to position the patient P at a steep angle. The pillow 10 may be installed on the operating table OT in the same way.

The operating table OT is a conventional operating table of the type configured to enable the Trendelenburg position characterized by the operating table OT positioned to orient the patient P at a steep angle greater than about 28 degrees. The operating table OT has conventional side rails SR and rail clamps RC that are used with a variety of surgical accessories such as arm supports, leg supports, and anesthesia screens. The side rails SR and rail clamps RC are typically on both sides of the operating table OT. As described herein, a side rail SR and rail clamp RC on one side of the operating table OT or on both sides of the operating table OT can be used to secure the pillows 10 and 30.

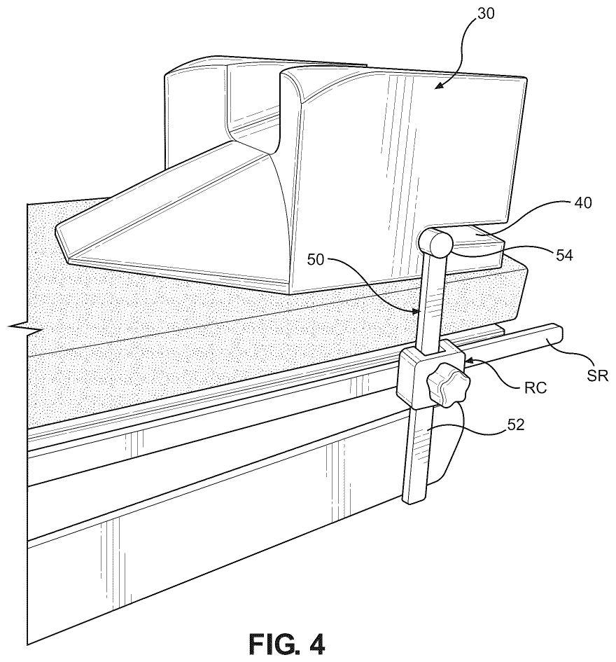

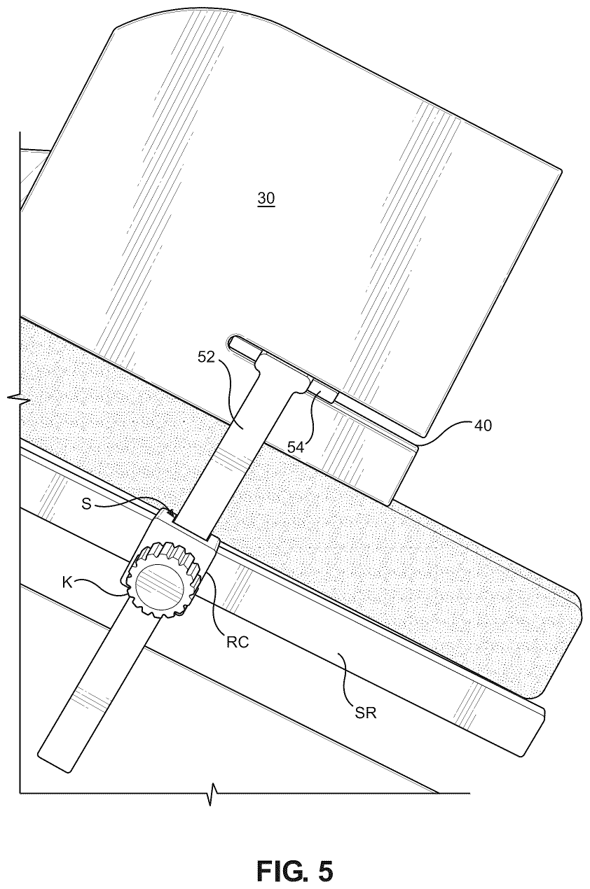

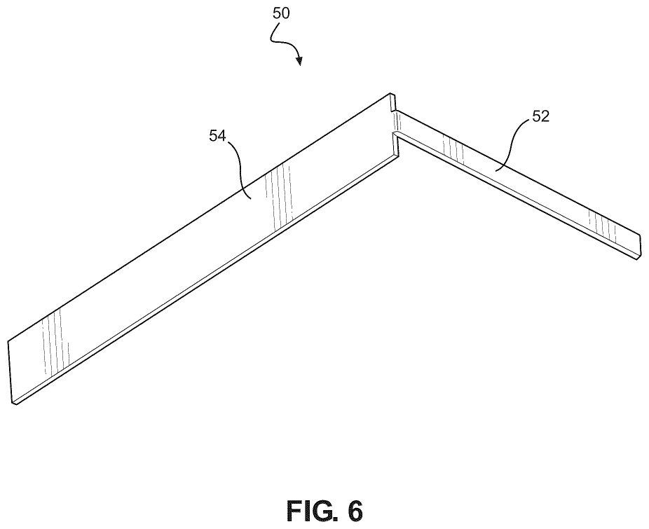

With additional reference to FIGS. 4 and 5, the pillow 30 may be installed on the operating table OT using a bar 50 or two of the bars 50. With additional reference to FIG. 6, the bar 50 is desirably of rigid metal construction and has a vertical member 52 and a horizontal member 54 that extends outwardly from a distal end of the vertical member 52.

The vertical member 52 is configured to be adjustably received by the rail clamp RC and the horizontal member 54 is received by the channel 40. As shown, the vertical member 52 and the horizontal member 54 are of a flat profile but can be of a variety of profiles depending on the profile of the rail clamp RC and the profile of the channel 40. The horizontal member 54 is configured to be received by the channel 40 and can be made in various lengths. If one of the bars 50 is to be used, then the horizontal member 54 may be of a longer length than if two of the bars 50 are used. The bar 50 can be made of various rigid strong materials such as metal, plastic, carbon fiber and other suitable composite materials.

In this regard, the rail clamps RC are adjustably positionable along the side rails SR and include a clamping structure such as a knob K for securing the rail clamp RC in place along the side rail SR. As shown, the rail clamp RC also includes a slot S through which the vertical member 52 is adjustably received. When the knob K of the rail clamp RC is tightened, it fixes both the position of the vertical member 52 relative to the rail clamp RC and the position of the rail clamp RC along the side rail SR.

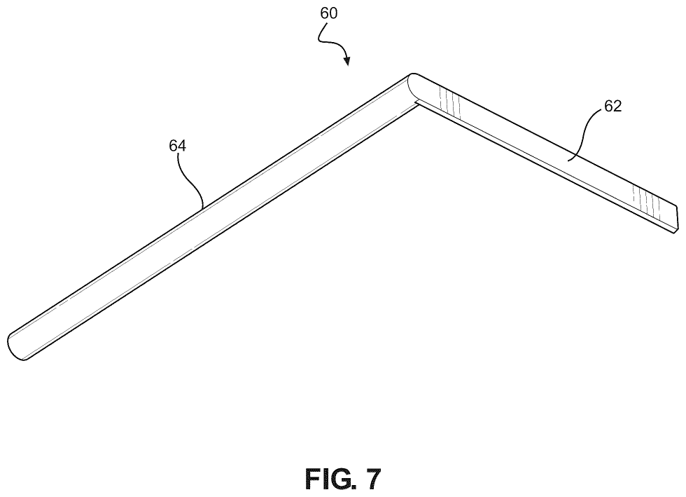

FIG. 7 shows an alternate embodiment of a bar 60. The bar 60 has a vertical member 62 and a horizontal member 64. The bar 60 differs from the bar 50 in that the horizontal member 64 has a cylindrical shape which desirably more fully fits the channel 40 and increases surface area contact with the channel 40.

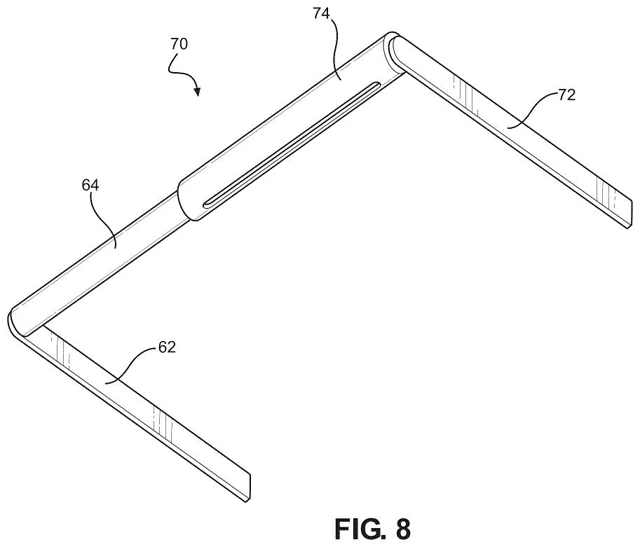

FIG. 8 shows a further embodiment of a telescoping bar 70. The telescoping bar 70 is desirably for use when it is desired to secure the pillows 10 or 30 to the operating table OT using one of the side rails SR and rail clamps RC on both sides of the operating table OT. As seen, the telescoping bar has a bar corresponding to the bar 60 with the vertical member 62 and the horizontal member 64, with a second bar having a vertical member 72 and a horizontal member 74. The horizontal member 74 is provided as a cylinder sized to slidingly receive the horizontal member 64.

Turning to FIG. 9, there is shown a further embodiment of the pillow 30. The pillow 30 is identical to the pillow 30 described in connection with FIGS. 2A-2D, except that the channel 40 is not continuous. As will be noted, the channel 40 extends into both of the side member 36 and 38, but does not extend below the central plateau 34. As shown, the bars used, shown as two of the bars 50, are shorter. This embodiment avoids having the bars 50, or other securement member, immediately below the head of the patient P.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated.

1. A surgical pillow positionable on a patient support surface and securable in a fixed position relative to the patient support surface, comprising:
a foam body having a front ramp abutting and aligned with a planar central plateau having an upper surface, the front ramp including side flares sloping away from opposite sides of the front ramp;
side members located on opposite sides of the front ramp and the central plateau and extending upwardly above the front ramp and the central plateau;
a channel formed across at least a portion of the width of the pillow and vertically lower than the upper surface of the central plateau; and
a rigid securement member having a vertical member securable in a fixed position relative to the patient support surface and a horizontal member received within the channel to fix the position of the surgical pillow relative to the patient support surface.

2. The surgical pillow of claim 1, wherein the planar central plateau is open to a rear of the pillow.

3. The surgical pillow of claim 1, wherein the channel opens to a rear of the pillow.

4. The surgical pillow of claim 1, wherein the upper surface of the central plateau is planar.

5. The surgical pillow of claim 1, wherein each side member includes a curved front wall that extends forward of the central plateau and curves outwardly from a juncture with the central plateau.

6. The surgical pillow of claim 1, wherein the front ramp is planar having a uniform slope of from about 20 to about 30 degrees

7. The surgical pillow of claim 1, wherein the side flares are convex.

8. The surgical pillow of claim 1, wherein the front ramp is made of a foam having a density of about 1.2 lbs/in³ and an indentation load deflection of about 30 and the central plateau and the side members are each made of a foam having a density of about 1.5 lbs/in³ and an indentation load deflection of about 55.
